(19) United States
(12) Patent Application Publication
(10) Pub. No.: US 2005/0165648 A1
(43) Pub. Date: Jul. 28, 2005

(54) Automatic call center for product ordering in retail system

(76) Inventor: Sergey N. Razumov, Moscow (RU)

Correspondence Address: McDERMOTT, WILL & EMERY, 600 13th Street, N.W., Washington, DC, 20005-3096, US

(21) Appl. No.: 10/762,374

(22) Filed: Jan. 23, 2004

(51) Int. Cl. G06F 17/60

(52) U.S. Cl. 705/26

(57) ABSTRACT

A system for processing telephone orders for goods being sold in a retail system. The system includes input telephone circuitry for receiving incoming telephone calls from customers, and order processing circuitry responsive to order information supplied from the input circuitry for conducting an interactive session with a customer to fulfil a request for an item being ordered without intervention of a human operator. The interactive session involves determination whether the requested item is available at the time of customer's request, and whether it can be delivered to a point of sale selected by the customer at a time interval requested by the customer.

### FIELD OF THE INVENTION

The present invention relates to retail systems, and more particularly, to an automatic call center for enabling customers to order goods via a telephone system.

### BACKGROUND OF THE INVENTION

A conventional call center for product ordering includes multiple call-handling human operators that receives incoming telephone calls from customers via a call distributor. A call-handling human operator interacts with a customer to determine requisite information on the customer and provide him or her with information on available products. A customer's order containing information on goods being ordered is manually entered into a retailer's data processing system. Using this system, the human operator may determine whether the order can be fulfilled.

To increase efficiency of order processing in a retail system, it would be desirable to create an automatic call center capable of handling telephone orders from customers without human operator's intervention.

### SUMMARY OF THE INVENTION

The present invention offers a novel system for processing telephone orders for goods being sold in a retail system. The system includes input telephone circuitry for receiving incoming telephone calls from customers, and order processing circuitry responsive to order information supplied from the input circuitry for conducting an interactive session with a customer to fulfil a request for an item being ordered without intervention of a human operator. The order processing circuitry may be configured to determine whether the requested item is available at the time of customer's request, and whether it can be delivered to a point of sale selected by the customer at a time interval requested by the customer.

In response to information identifying the customer, the order processing system may determine a customer's profile indicating preferences of the customer. For example, the customer's profile may contain a customer's voice sample for recognizing voice messages received from the customer.

The order processing circuitry may be configured to process a customer's voice message associated with the request for an item being ordered. The voice message may identify the customer, an item being ordered, a requested time interval for delivery, and a point of sale selected by the customer for delivery of the requested item.

Further, the order processing circuitry may be configured to produce a voice message providing the customer with information relating to the request for an item being ordered.

The processing system may also include control circuitry that interacts with the processing circuitry during the session with the customer. In particular, the control circuitry may interact with the processing circuitry during a telephone session with the customer to determine whether the customer's request can be fulfilled. Also, the control and database may provide the processing circuitry with a customer's profile indicating preferences of the customer.

In accordance with a method of the present invention the following steps are carried out to process a telephone order for an item:
receiving a telephone call from a customer, and
without intervention of a human operator, conducting an interactive session with the customer to fulfill a request to order the item.

The interactive session may include an exchange of voice messages to determine whether the requested item is available and whether it can be delivered to a selected point of sale during a requested time interval.

Still other aspects and advantages of the present invention will become readily apparent from the following detailed description, simply by way of illustration of the best mode contemplated of carrying out the invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 illustrates an architecture of the automatic call center of the present invention.

FIG. 2 shows an information exchange conducted during an interactive telephone session with a customer.

FIG. 3 illustrates a protocol of incoming call processing.

FIG. 4 illustrates a protocol of a customer validation procedure.

FIG. 5 illustrates a protocol of a card's number confirmation procedure.

FIG. 6 illustrates a protocol of a point of sale selection procedure.

FIG. 7 illustrates a protocol of a store's number confirmation procedure.

FIG. 8 illustrates a protocol of a delivery time selection procedure.

FIG. 9 illustrates a protocol of a product selection procedure.

FIG. 10 illustrates a protocol of a quantity selection procedure.

FIG. 11 illustrates a protocol of order validation procedure.

### DETAILED DESCRIPTION OF THE INVENTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and entities are shown in a block diagram form in order to avoid unnecessarily obscuring the present invention.

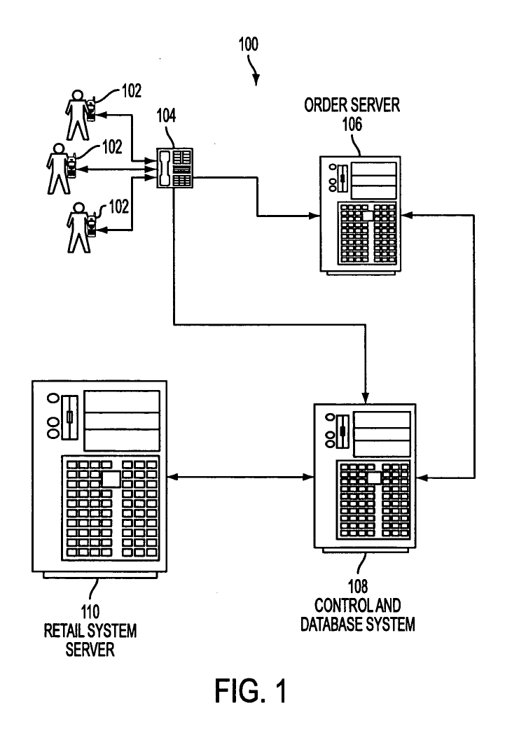

As shown in FIG. 1, an automatic call center 100 of the present invention interacts with customers 102 who place orders for goods using their telephone sets. For example, the automatic call center may be used for placing telephone orders for goods available in a retail system, such as a retail chain described in my copending application Ser. No. 09/788,674 filed on Feb. 21, 2001 and incorporated herewith by reference. This retail chain may include multiple points of sale, and product ordering system that enables a customer to order desired goods and pick them up at a point of sale selected by the customer during a time interval chosen by the customer.

The automatic call center 100 comprises a telephone distribution unit 104 providing an interface to multiple telephone lines transmitting incoming telephone calls from customers 102. The telephone distribution unit 104 directs the incoming telephone calls to an order server 106, which conducts an interactive session with each customer to fulfill a customer's request to order required items. A control and database system 108 of the call center 100 interacts with the order server 106 during the interactive session with a customer to provide the order server 106 with information required to complete the customer's order, such as a customer profile, information on points of sale and available products. When the session with a customer is completed, the order server 106 transfers a completed customer's order to the control and database system 108. From this system, the customer's order is submitted to a retail system server 110 that controls operations carried out to collect items listed in the customer's order and deliver them to a selected point of sale. Also, the retail system server 110 provides the control and database system 108 with updated information on points of sale and products available in the retail system.

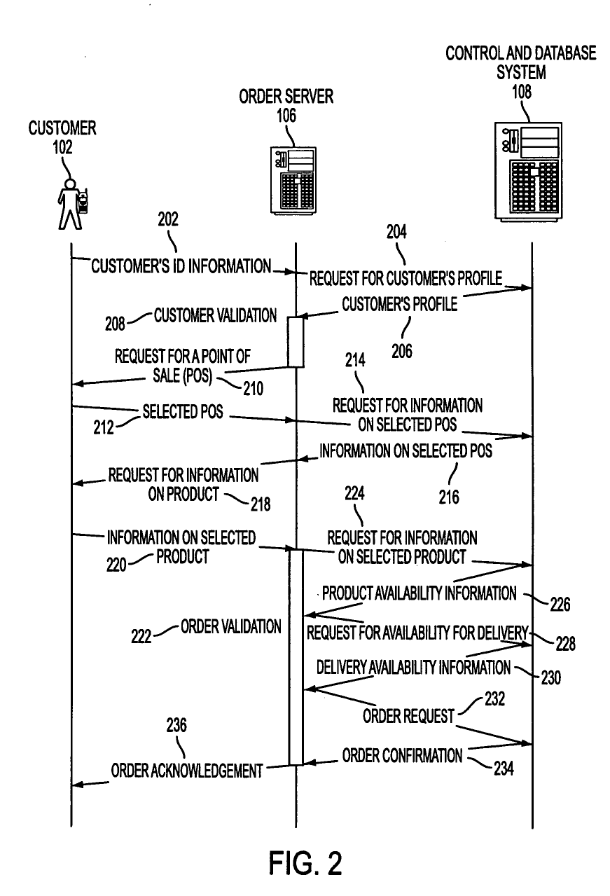

FIG. 2 illustrates a simplified protocol of information exchange between the customer 102, order server 106, and control and database system 108 during an interactive session conducted with a customer to enable him or her to place an order for goods available in the retail system. The interactive session is initiated when a customer places a telephone call to the call center 100 to order required goods. As will be discussed in more detail below, the interactive session may include an exchange of voice messages between the customer 102 and the order server 106. Also, the customer may enter required information using a pushbutton telephone dial in a tone dial mode. At the beginning of the session, the customer is requested to enter identification information. For example, the customer may be identified by the number of a shopping card issued by the retail system or by the number of a credit card. Alternatively, the customer may be identified by his telephone number or any other appropriate ID information.

As shown in FIG. 2, when the customer 102 enters ID information, such as the number of the shopping card (step 202), the order server 106 requests the control and database system 108 to retrieve a customer's profile corresponding to the entered ID information (step 204). The customer's profile, which may be set up when the customer is enrolled as a customer of the retail system, may include information on customer's preferences. For example, it may include information on a preferred point of sale and time of delivery, and information on goods frequently ordered by the customer. Also, the customer's profile may include information required to validate the number of shopping or credit card entered by the customer. In addition, the customer's profile may include customer's voice samples used to facilitate recognition of voice messages received from that customer.

In response to the request from the order server 106, the control and database system 108 transfers the customer's profile information to the order terminal 106 (step 206), which validates the number of shopping or credit card entered by the customer based on the received profile information (step 208). If the number is valid, the order terminal 106 requests the customer 102 to select a point of sale for delivery of the ordered goods (step 210).

When the customer 102 enters information identifying a desired point of sale, for example, the ID number of a store in the retail system (step 212), the order server 106 sends to the control and database system 108 a request for information on the selected point of sale (step 214). After receiving this information from the control and database system 108 (step 216), the order server 106 may send to the customer 102 a voice message containing the ID information of the selected point of sale and requesting the customer to confirm that this information is correct. Further, the customer 102 may be requested to enter a desired time for delivery of the ordered goods.

After receiving information on point of sale and time for delivery, the order server 106 requests the customer 102 to identify an item that he or she wants to order (step 218). For example, the customer may identify this item using a catalog of available goods provided by the retail system. This catalog may contain various information describing the goods, such as the name of a manufacturer, size, price, etc. In addition, each product in the catalog may be identified by a code.

To identify a desired product, the customer 102 may enter the code of the respective product listed in the catalog. Alternatively, the customer may identify a desired product by a voice command containing a word or a phrase identifying the product. Further, the customer is requested to enter the quantity of the product being ordered. When the customer 102 completes entering information on the desired product (step 220), the order server 106 initiates an order validation procedure 222 to determine whether the retail system is able to fulfill the customer's order for a requested product. The order validation procedure 222 involves an information exchange between the order server 106 and the control and database system 108.

The order validation procedure 222 is initiated when the order server 106 sends to the control and database system 108 a request for information on the product ordered by the customer 102 (step 224). The control and database system 108 may respond with product availability information indicating whether or not the product is available in the retail system at the time of request (step 226).

If the product is not available, the information from the control and database system 108 may include information on a similar product available at the time of request. The order server 106 terminates the order validation procedure, and requests the customer to order another product. In addition, the order server 106 may provide a voice message suggesting the available product indicated by the control and database system 108.

If the product is available, the order server 106 sends to the control and database system 108 a request for information on whether or not the product can be delivered to the point of sale selected by the customer at the time selected by the customer (step 228). The control and database system 108 responds with information indicating whether or not the product is available for delivery to the selected point of sale and the selected time (step 230).

For example, the control and database system 108 may make a decision on product's availability for delivery to the selected point of sale at the selected time based on information on whether the requested product is available in a storage facility located near the selected point of sale or should be requested from a remote storage facility. Also, the control and database system 108 may consider a schedule of transportation means to determine whether the requested product can be transported from a storage facility to the selected point of sale at the selected time. Further, the control and database system 108 may take into consideration whether a store selected by the customer as a point of sale is open at the time selected by the customer.

If for any reason the product is not available for delivery to the selected point of sale at the selected time, the control and database system 108 may provide the order server 106 with information on a time period when the requested product can be delivered to the selected point of sale. Also, the control and database system 108 may supply the order server 106 with information on an alternative point of sale, at which the requested product can be delivered at the time selected by the customer. The order server 106 terminates the order validation procedure, and requests the customer 102 to select another time for delivery or another point of sale. In addition, the order server 106 may produce a voice message suggesting another time for delivery and/or an alternative point of sale in accordance with the information provided by the control and database system 108.

If the control and database system 108 determines that a requested product is available for delivery to the selected point of sale at the selected time, the order server 106 requests the customer 102 to identify the next product to be included in the customer's order. Upon receiving the product information from the customer 102, the order server 106 interacts with the control and database system 108 to determine whether the product is available and can be delivered to the selected point of sale at the selected time.

When the control and database system 108 confirms that all products in the customer's order are available and may be delivered to the selected point of sale at the selected time, the order server 106 forms an order request including all ordered items, the selected point of sale and delivery time. The order request is supplied to the control and database system 108 (step 232) which replies with an order confirmation (step 234). The order confirmation may include the total price of the order and the number of items being ordered. In response to the order confirmation, the order server 106 produces a voice message informing the customer 102 that the order is accepted (step 236). The control and database system 108 transfers the customer's order to the retail system server 110 that controls operations required to deliver the customer's order to the selected point of sale at the selected time.

Hence, during an interactive session conducted with a customer, the automatic call center 100 is able, without intervention of a human operator, to accept the customer's request for products and to determine that the request may be fulfilled, i.e. requested products are available at the time of request and can be delivered to a point of sale selected by the customer at a time selected by the customer.

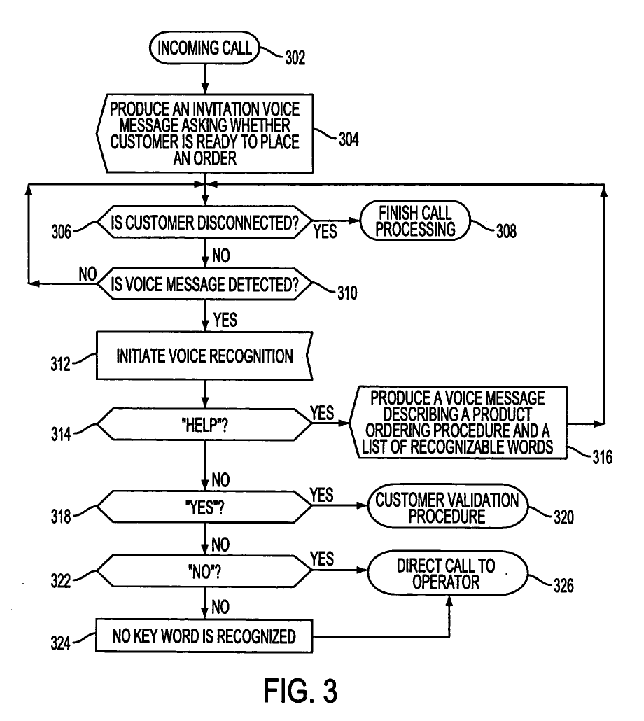

FIGS. 3 to 11 illustrate the interaction between the client 102 and the order server 106 in more detail. In particular, as shown in FIG. 3, in response to an incoming call from the customer 102 (block 302), the order server 106 produces a voice message inviting the customer to an automatic call center of a retail system and asking him whether he is ready to place an order (block 304). Various voice message producing procedures may be used by the order server 106. For example, voice messages may be pre-recorded or a voice synthesizer may be used. If the customer is disconnected (block 306), a call processing procedure is completed (block 308).

If the customer is not disconnected, the order server 106 waits for a voice message from the client (block 310). If the voice message is detected, the order server 106 initiates a voice message recognition procedure (block 312).

An exemplary voice message recognition procedure that may be carried out by the order server 106 is based on recognizing a limited number of spoken words. For example, the order server 106 may be trained to recognize spoken words representing the numbers from “zero” to “nine”, and such spoken words as “help”, “yes no”, “end”, “exit”, “accept”, “change”, “morning”, “evening”, etc.

If the order server 106 recognizes the word “help” (block 314) in response to the invitational voice message, the order server 106 produces a voice message describing a product ordering procedure and a list of recognizable words (block 316). If the word “yes” is detected (block 318), the order server 106 goes to a customer validation procedure (block 320). If the word “no” is detected (block 322) or no key word is recognized (block 324), the order server 106 may direct the incoming call to an operator (block 326).

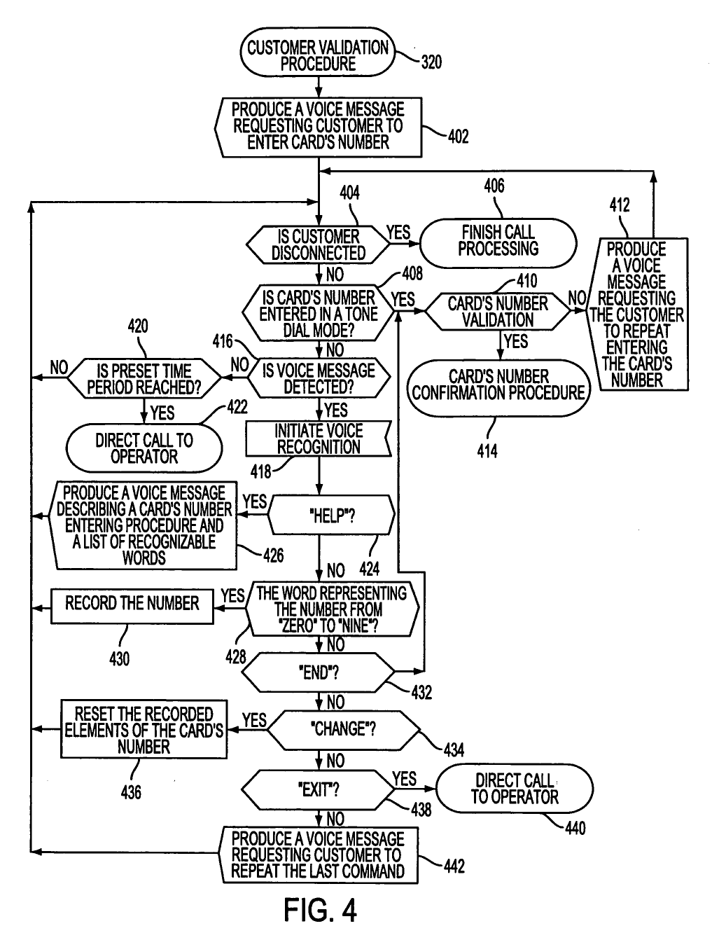

As shown in FIG. 4, the customer validation procedure 320 may be initiated by producing a voice message requesting the customer 102 to say the ID number of customer's shopping card or to enter this number using a pushbutton telephone dial in a tone dial mode (block 402). If the customer is disconnected (block 404), a call processing procedure is completed (block 406). If the customer is not disconnected, the order server 106 determines whether the card's number is entered in a tone dial mode (block 408).

If so, the order server 106 interacts with the control and database system 108 to validate the card's number (block 410). If the card's number is not valid, the order server 106 produces a voice message requesting the customer to repeat entering the card's number (block 412). If the card's number is valid, the order server 106 goes to a card's number confirmation procedure (block 414).

If the card's number is not entered in a tone dial mode, the order server 106 determines whether a voice message from the customer is detected (block 416). If so, a voice recognition procedure is initiated (block 418). If no voice message is detected, the order server 106 waits for a preset time period (block 420) and directs the call to an operator (block 422).

If the order server 106 recognizes the word “help” (block 424), it produces a voice message describing a card's number entering procedure and a list of recognizable words (block 426). If the word representing the number from “zero” to “nine” is detected (block 428), the order server 106 records the respective number as an element of the card's number (block 430).

The card's number recognition procedure continues until the word “end” is recognized (block 432). In response to this word, the order server 106 goes to the card's number validation procedure (block 410). If the word “change” is detected (block 434), the order server 106 may reset the recorded elements of the card's number (block 436). In response to the word “exit” (block 438), the order server 106 may direct the call to an operator (block 440). If no word is recognized, a voice message is produced requesting the customer to repeat the last command (block 442).

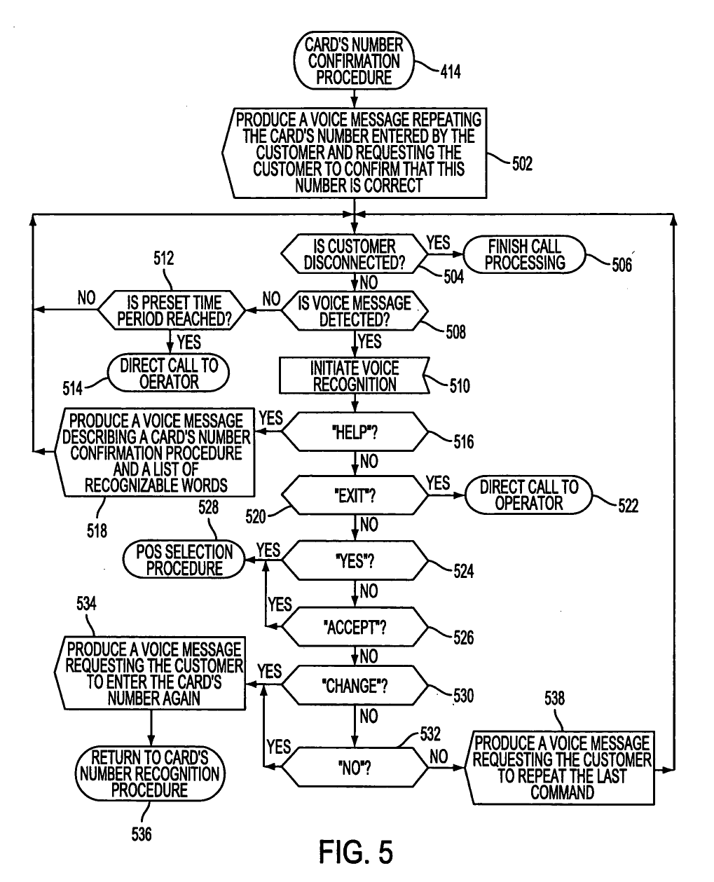

Referring to FIG. 5, the card number confirmation procedure (block 414) is initiated by the order server 106 that produces a voice message repeating the card's number entered by the customer and requesting the customer to confirm that this number is correct (block 502). If the customer is disconnected (block 504), the call processing procedure is completed (block 506). If the customer is not disconnected, the order server 106 determines whether a voice message from the customer is detected (block 508). If so, a voice recognition procedure is initiated (block 510). If no voice message is detected, the order server 106 waits for a preset time period (block 512) and directs the call to an operator (block 514).

If the order server 106 recognizes the word “help” (block 516), it produces a voice message describing a card number confirmation procedure and a list of recognizable words (block 518). In response to the word “exit” (block 520), the order server 106 may direct the call to an operator (block 522). If the word “yes” (block 524) or the word “accept” (block 526) is recognized, the order server 106 goes to a point of sale (POS) selection procedure (block 528).

In response to the word “change” (block 530) or the word “no” (block 532), the order server 106 produces a voice message requesting the customer to enter the card's number again (block 534) and returns to the card's number recognition procedure (block 536). If no word is recognized, a voice message is produced requesting the customer to repeat the last command (block 538).

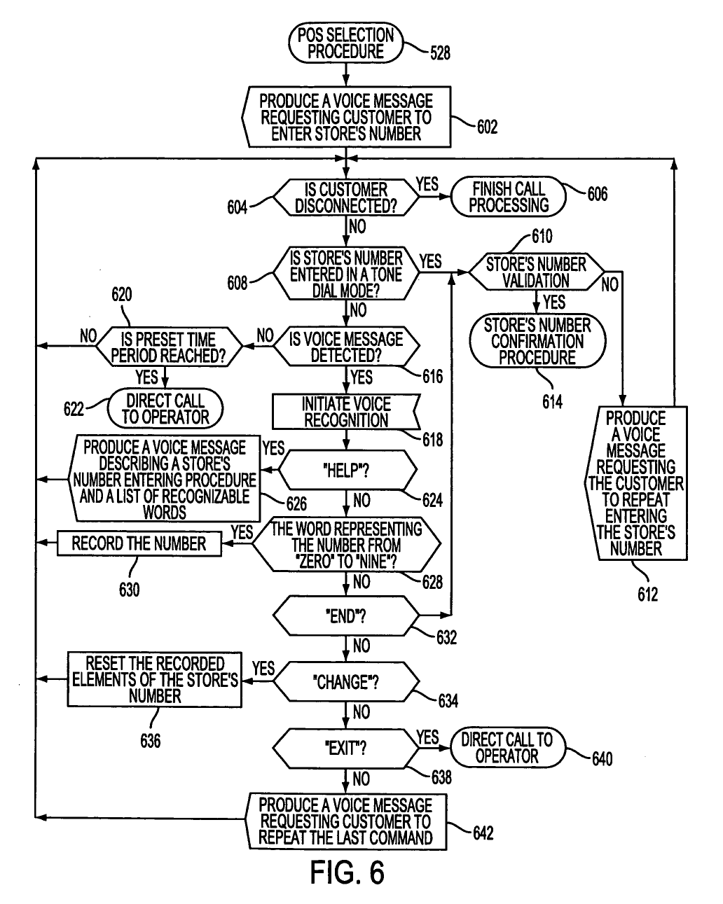

As shown in FIG. 6, a POS selection procedure (block 528) is initiated by the order server 106 that produces a voice message requesting the customer to select a point of sale for delivery products being ordered (block 602). For example, the customer may be requested to enter the identification number of a retail facility, such as a store, in the retail system. This identification number may be listed in a catalog issued by the retail system. If the customer is disconnected (block 604), a call processing procedure is completed (block 606). If the customer is not disconnected, the order server 106 determines whether the store's number is entered in a tone dial mode (block 608).

If so, the order server 106 interacts with the control and database system 108 to validate the store's number (block 610). If the store's number is not valid, the order server 106 produces a voice message requesting the customer to repeat entering the store's number (block 612). If the store's number is valid, the order server 106 goes to a store's number confirmation procedure (block 614).

If the store's number is not entered in a tone dial mode, the order server 106 determines whether a voice message from the customer is detected (block 616). If so, a voice recognition procedure is initiated (block 618). If no voice message is detected, the order server 106 waits for a preset time period (block 620) and directs the call to an operator (block 622).

If the order server 106 recognizes the word “help” (block 624), it produces a voice message describing a store's number entering procedure and a list of recognizable words (block 626). If the word representing the number from “zero” to “nine” is detected (block 628), the order server 106 records the respective number as an element of the card's number (block 630).

The store's number recognition procedure continues until the word “end” is recognized (block 632). In response to this word, the order server 106 goes to the store's number validation procedure (block 610). If the word “change” is detected (block 634), the order server 106 may reset the recorded elements of the store's number (block 636). In response to the word “exit” (block 638), the order server 106 may direct the call to an operator (block 640). If no word is recognized, a voice message is produced requesting the customer to repeat the last command (block 642).

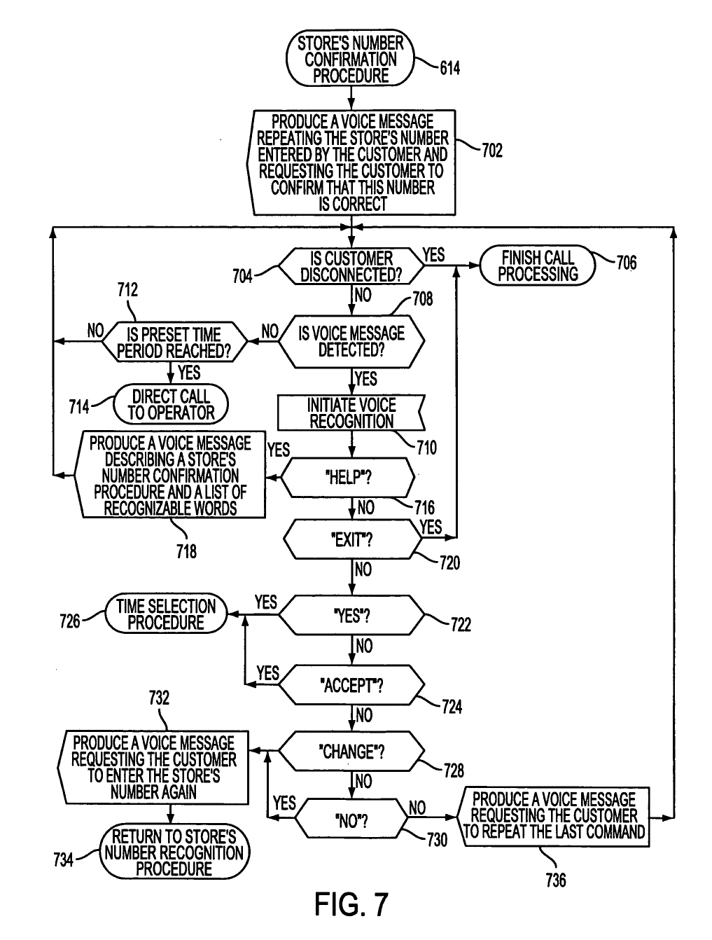

Referring to FIG. 7, the store's number confirmation procedure (block 614) is initiated by the order server 106 that produces a voice message repeating the store's number entered by the customer and requesting the customer to confirm that this number is correct (block 702). If the customer is disconnected (block 704), the call processing procedure is completed (block 706). If the customer is not disconnected, the order server 106 determines whether a voice message from the customer is detected (block 708). If so, a voice recognition procedure is initiated (block 710). If no voice message is detected, the order server 106 waits for a preset time period (block 712) and directs the call to an operator (block 714).

If the order server 106 recognizes the word “help” (block 716), it produces a voice message describing a store's number confirmation procedure and a list of recognizable words (block 718). In response to the word “exit” (block 720), the order server 106 finish call processing (block 706). If the word “yes” (block 722) or the word “accept” (block 724) is recognized, the order server 106 goes to a time selection procedure (block 726).

In response to the word “change” (block 728) or the word “no” (block 730), the order server 106 produces a voice message requesting the customer to enter the store's number again (block 732) and returns to the store's number entering procedure (block 734). If no word is recognized, a voice message is produced requesting the customer to repeat the last command (block 736).

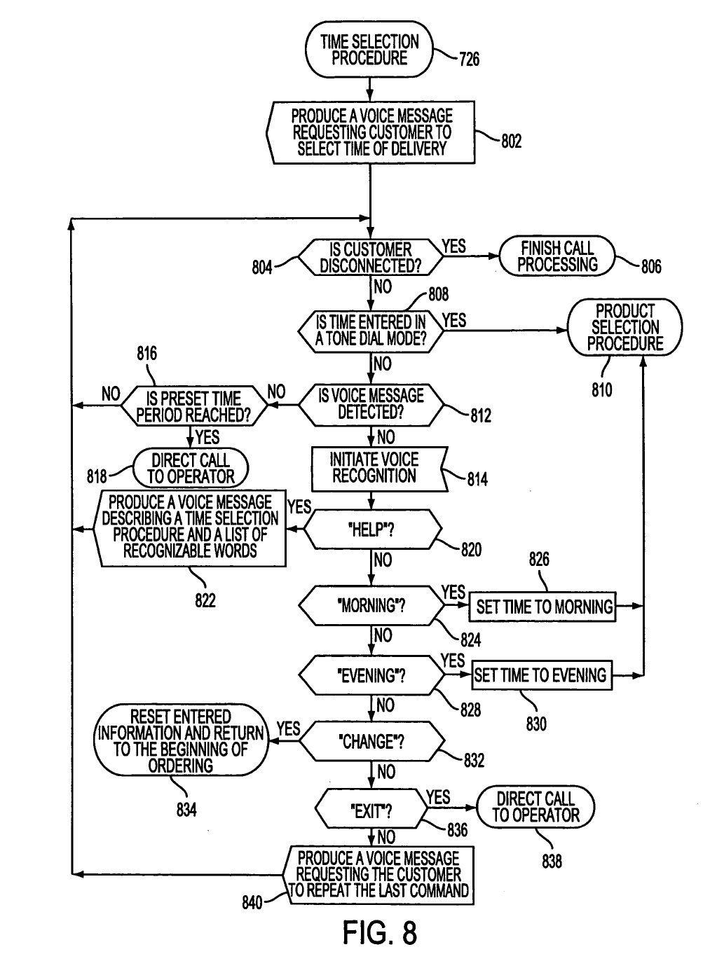

As shown in FIG. 8, a time selection procedure (block 726) is initiated by the order server 106 that produces a voice message requesting the customer to select a time for delivery products being ordered (block 802). If the customer is disconnected (block 804), a call processing procedure is completed (block 806). If the customer is not disconnected, the order server 106 determines whether the time is entered in a tone dial mode (block 808). If so, the order server 106 goes to a product selection procedure (block 810).

If the time is not entered in a tone dial mode, the order server 106 determines whether a voice message from the customer is detected (block 812). If so, a voice recognition procedure is initiated (block 814). If no voice message is detected, the order server 106 waits for a preset time period (block 816) and directs the call to an operator (block 818).

If the order server 106 recognizes the word “help” (block 820), it produces a voice message describing a time selection procedure and a list of recognizable words (block 822). The time for delivery may be represented by recognizable words defining various time periods of the day, such as “morning” and “evening”. For example, if the word “morning” is recognized (block 824), the time for delivery is set during a predetermine time period in the morning of a requested day (block 826). If the word “evening” is recognized (block 828), the time for delivery is set during a predetermine time period in the morning of a requested day (block 830). The requested day for delivery may be set by default to the same day, if ordering is performed in the morning, or to the next day, if ordering is performed in the afternoon. Alternatively, the system may be set to recognize the numbers representing the date of delivery.

In response to the word “change” (block 832), the order server 106 may reset the entered information and return to the beginning of the ordering procedure (block 834). In response to the word “exit” (block 836), the order server 106 may direct the call to an operator (block 838). If no word is recognized, a voice message is produced requesting the customer to repeat the last command (block 840).

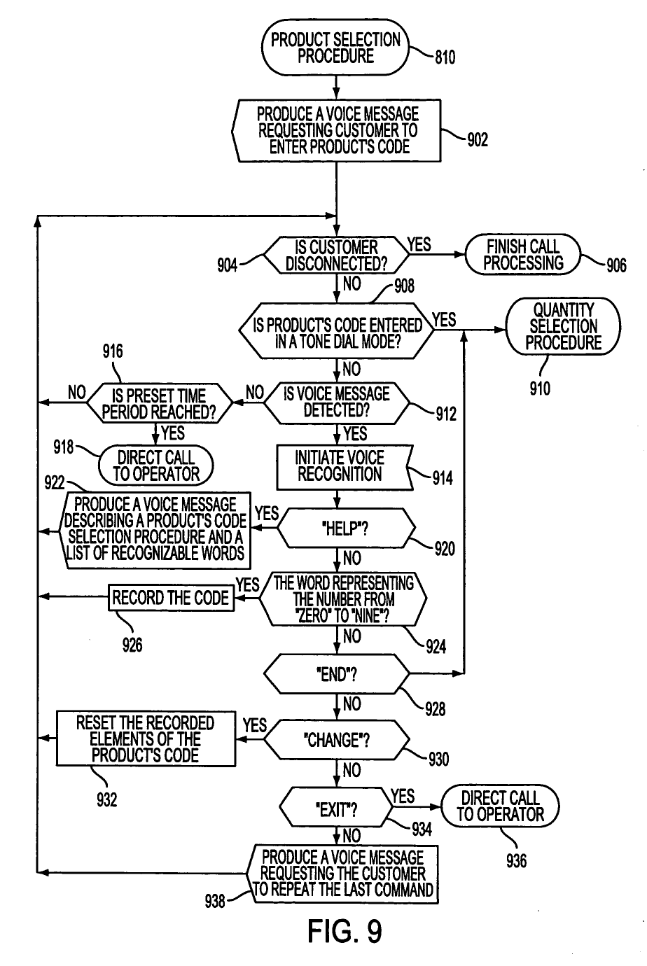

As shown in FIG. 9, a product selection procedure (block 810) is initiated by the order server 106 that produces a voice message requesting the customer to select a product being ordered (block 902). For example, the customer may be requested to enter an identification code of a product listed in a catalog issued by the retail system. If the customer is disconnected (block 904), a call processing procedure is completed (block 906). If the customer is not disconnected, the order server 106 determines whether the product's code is entered in a tone dial mode (block 908). If so, the order server 106 goes to a quantity selection procedure (block 910).

If the product's code is not entered in a tone dial mode, the order server 106 determines whether a voice message from the customer is detected (block 912). If so, a voice recognition procedure is initiated (block 914). If no voice message is detected, the order server 106 waits for a preset time period (block 916) and directs the call to an operator (block 918).

If the order server 106 recognizes the word “help” (block 920), it produces a voice message describing a product's code selection procedure and a list of recognizable words (block 922). If the word representing the number from “zero” to “nine” is detected (block 924), the order server 106 records the respective number as an element of the product's code (block 926).

The product's code recognition procedure continues until the word “end” is recognized (block 928). In response to this word, the order server 106 goes to the quantity selection procedure (block 910). If the word “change” is detected (block 930), the order server 106 may reset the recorded elements of the product's code (block 932). In response to the word “exit” (block 934), the order server 106 may direct the call to an operator (block 936). If no word is recognized, a voice message is produced requesting the customer to repeat the last command (block 938).

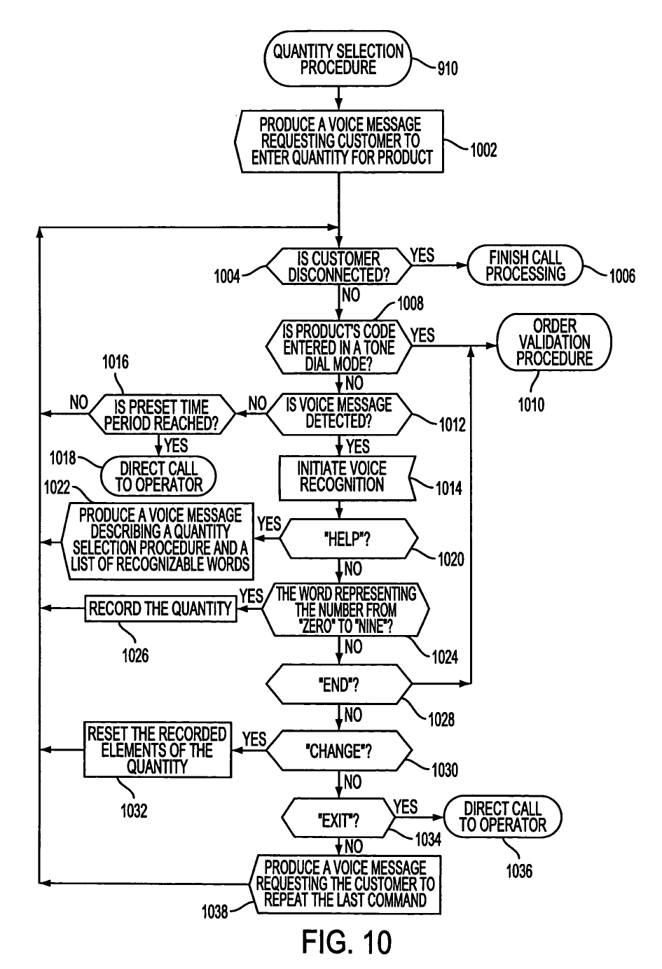

Referring to FIG. 10, a quantity selection procedure (block 910) is initiated by the order server 106 that produces a voice message requesting the customer to select quantity for the product being ordered (block 1002). If the customer is disconnected (block 1004), a call processing procedure is completed (block 1006). If the customer is not disconnected, the order server 106 determines whether the quantity is entered in a tone dial mode (block 1008). If so, the order server 106 goes to an order validation procedure (block 1010).

If the quantity is not entered in a tone dial mode, the order server 106 determines whether a voice message from the customer is detected (block 1012). If so, a voice recognition procedure is initiated (block 1014). If no voice message is detected, the order server 106 waits for a preset time period (block 1016) and directs the call to an operator (block 1018).

If the order server 106 recognizes the word “help” (block 1020), it produces a voice message describing a quantity selection procedure and a list of recognizable words (block 1022). If the word representing the number from “zero” to “nine” is detected (block 1024), the order server 106 records the respective number as an element of the quantity (block 1026).

The quantity recognition procedure continues until the word “end” is recognized (block 1028). In response to this word, the order server 106 goes to the order validation procedure (block 1010). If the word “change” is detected (block 1030), the order server 106 may reset the recorded elements of the quantity (block 1032). In response to the word “exit” (block 1034), the order server 106 may direct the call to an operator (block 1036). If no word is recognized, a voice message is produced requesting the customer to repeat the last command (block 1038). Although, the present application describes selection of one product, one skilled in the art would recognize that any number of products may be selected during a single interactive session with a customer.

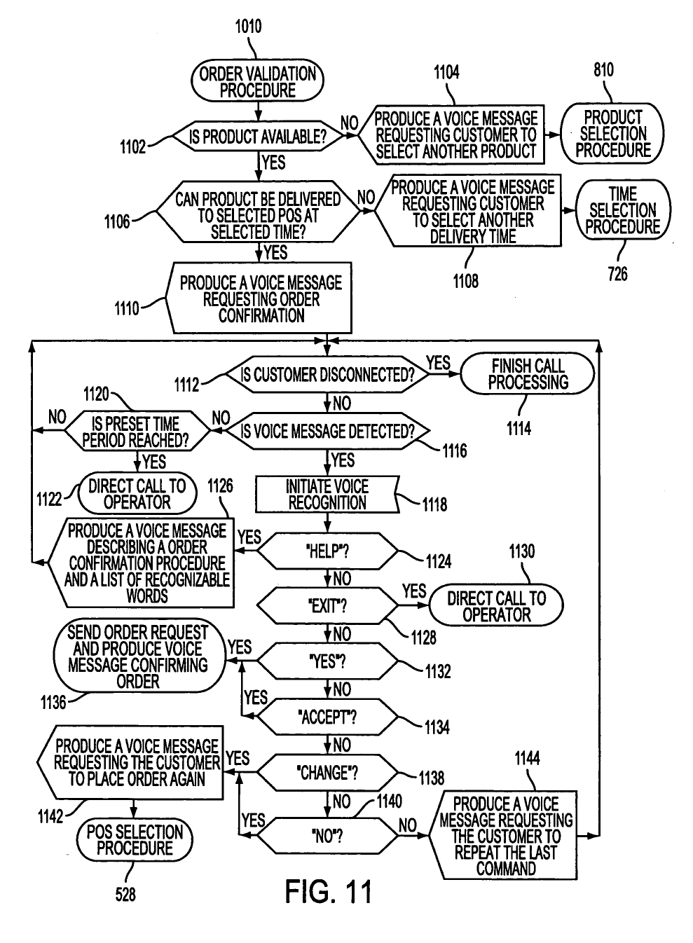

Referring to FIG. 11, the order validation procedure 1010 enables the automatic call center to determine whether a customer's order for a particular product can be fulfilled. The order validation procedure 1010 includes a step, during which the order server 106 interacts with the control and database system 108 to determine whether the product being requested is available at the time of request (block 1102). If no, the order server 106 produces a voice message informing the customer that the product is not available and suggesting to the customer to select another product (block 1104). The order server 106 may recommend a product similar to the unavailable product. Thereafter, the order server 106 returns to a product selection procedure 810.

If the product being ordered is available at the time of request, the order server 106 interacts with the control and database system 108 to determine whether or not the product can be delivered to the point of sale selected by the customer at the time selected by the customer (block 1106). If no, the order server 106 produces a voice message informing the customer that the product cannot be delivered at the selected time and suggesting to select another delivery time (block 1108). The order server 106 may indicate time periods when the product can be delivered. Thereafter, the order server 106 returns to a time selection procedure 726. Alternatively, the order server may suggest another point of sale, where the product may be received at the time requested by the customer, and return to a point of sale selection procedure.

If the product can be delivered to the selected point of sale at the selected time, the order server 106 produces a voice message describing the order and requesting the customer to confirm it (block 1110). If the customer is disconnected (block 1112), the call processing procedure is completed (block 1114). If the customer is not disconnected, the order server 106 determines whether a voice message from the customer is detected (block 1116). If so, a voice recognition procedure is initiated (block 1118). If no voice message is detected, the order server 106 waits for a preset time period (block 1120) and directs the call to an operator (block 1122).

If the order server 106 recognizes the word “help” (block 1124), it produces a voice message describing an order confirmation procedure and a list of recognizable words (block 1126). In response to the word “exit” (block 1128), the order server 106 directs the call to an operator (block 1130). If the word “yes” (block 1132) or the word “accept” (block 1134) is recognized, the order server 106 sends an order request containing information on the order to the control and database system 108, and after receiving confirmation from the system 108 that the order is accepted, produces a voice message confirming the order (block 1136).

In response to the word “change” (block 1138) or the word “no” (block 1140), the order server 106 may produce a voice message requesting the customer to repeat placing an order (block 1142) and return to the point of sale selection procedure (block 528). If no word is recognized, a voice message is produced requesting the customer to repeat the last command (block 1144).

Hence, the automatic call center of the present invention is enabled during an interactive telephone session with a customer to automatically accept a customer's order for requested products and automatically determine whether the order can be fulfilled.

Those skilled in the art will recognize that the present invention admits of a number of modifications, within the spirit and scope of the inventive concepts. For instance, the present application describes an example of interactions between a customer, the order server 106 and the control and database system 108, and an example of a telephone interactive session between a customer and the order server 106. One skilled in the art will recognize that multiple variations may be made to these examples.

Further, the order server 106 and the control and database system 108 may be implemented in a number of different ways. For example, they may be implemented using specifically engineered chips having logic circuits and other components for performing the functions described above. Alternatively, the elements of the call center may be implemented using general purpose digital signal processors and appropriate programming.

While the foregoing has described what are considered to be preferred embodiments of the invention it is understood that various modifications may be made therein and that the invention may be implemented in various forms and embodiments, and that it may be applied in numerous applications, only some of which have been described herein. It is intended by the following claims to claim all such modifications and variations which fall within the true scope of the invention.

1. A system for processing telephone orders comprising:
input telephone circuitry for receiving incoming telephone calls from customers, and
order processing circuitry responsive to order information supplied from the input circuitry for conducting an interactive session with a customer to fulfil a request for an item being ordered, without intervention of a human operator.

2. The system of claim 1, wherein the order processing circuitry is configured to determine whether the requested item is available, before completing the interactive session.

3. The system of claim 1, wherein the order processing circuitry is configured to determine whether the requested item is available for delivery during a time interval requested by the customer, before completing the interactive session.

4. The system of claim 1, wherein the order processing circuitry is configured to request delivery of the item to a point of sale selected by the customer.

5. The system of claim 1, wherein the order processing system is responsive to information identifying the customer for determining a customer's profile indicating preferences of the customer.

6. The system of claim 5, wherein the customer's profile contain a customer's voice sample for recognizing voice messages received from the customer.

7. The system of claim 1, wherein the order processing circuitry is configured to process a customer's voice message associated with the request for an item being ordered.

8. The system of claim 7, wherein the voice message identifies the requested item.

9. The system of claim 7, wherein the voice message identifies a requested time interval for delivery.

10. The system of claim 7, wherein the voice message identifies a requested point of sale.

11. The system of claim 7, wherein the voice message identifies the customer.

12. The system of claim 1, wherein the order processing circuitry is configured to produce a voice message providing the customer with information relating to the request for an item being ordered.

13. The system of claim 1, further comprising control circuitry configured to interact with the processing circuitry during the session with the customer.

14. The system of claim 13, wherein the processing circuitry interacts with the control circuitry during the session with the customer to determine whether the request for an item can be fulfilled.

15. The system of claim 13, wherein during the session with the customer, the control circuitry provides the processing circuitry with a customer's profile indicating preferences of the customer.

16. The system of claim 13, wherein during the session with the customer, the control circuitry provides the processing circuitry with information on a point of sale selected by the customer.

17. The system of claim 13, wherein during the session with the customer, the control circuitry provides the processing circuitry with information on availability of the item requested by the customer.

18. A method of processing a telephone order for an item comprising:
receiving a telephone call from a customer, and
without intervention of a human operator, conducting an interactive session with the customer to fulfill a request to order the item.

19. The method of claim 18, wherein the interactive session includes an exchange of voice messages.

20. The method of claim 18, wherein the interactive session includes determining whether the requested item is available.

21. The method of claim 18, wherein the interactive session includes determining whether the requested item is available for delivery during a time interval requested by the customer.

22. A call center for ordering products in a retail system, the call center comprising:
an input telephone circuit for receiving a telephone call from a customer, and
a processing unit responsive to information supplied by the customer to fulfill a customer's request to order an item, whereby the item is ordered without intervention of a human operator.
